(19) United States
(12) Patent Application Publication
(10) Pub. No.: US 2026/0281596 A1
(43) Pub. Date: Sep. 17, 2026

(54) Rogue ONU Detection

(71) Applicant: ADTRAN, Inc., Huntsville, AL (US)

(72) Inventors: Sanjai Pandey, Huntsville, AL (US); Jonathan Wright, Huntsville, AL (US)

(21) Appl. No.: 19/473,320

(22) PCT Filed: Apr. 4, 2024
(86) PCT No.: PCT/US2024/023092

§ 371 Date: Oct. 7, 2025

Related U.S. Application Data
(60) Provisional application No. 63/458,267, filed on Apr. 10, 2023.

(51) Int. Cl. H04Q 11/00

(52) U.S. Cl. CPC H04Q 11/0067; H04Q 2011/0081; H04Q 2011/0083

(57) ABSTRACT

Methods, systems, and apparatus for detecting candidate rogue Optical Network Unit (ONU) are disclosed. An Optical Line Terminal (OLT) aggregates, over a specified time period, values of multiple network conditions of a passive optical network (PON) that includes ONUs actively transmitting over the PON. The OLT determines that aggregated values of a given condition (i) have statistically trended in only one direction over the specified time period, and (ii) are currently over a specified threshold value. The OLT classifies a given ONU from among the ONUs as a candidate rogue ONU that is qualified for further analysis based on the determination that the aggregated values of the given ONU (i) have statistically trended in only one direction over the specified time period, and (ii) are currently over the specified threshold value. The OLT triggers a discovery process that further analyzes the candidate rogue ONU based on the classification.

### BACKGROUND

A Passive Optical Network (PON) can include an Optical Line Terminal (OLT) and Optical Networking Units (ONUs). The OLT can transmit downstream data traffic to the ONUs, and receives upstream data traffic from the ONUs. The OLT can detect errors during transmissions from the ONUs.

### SUMMARY

Systems, methods, devices, and non-transitory, computer-readable media are disclosed for detecting a candidate rogue ONU on a PON. One example computer-implemented method includes aggregating, by an optical line terminal (OLT) and over a specified time period, values of multiple network conditions of a passive optical network (PON) that includes optical networking units (ONUs) actively transmitting over the PON; determining, by the OLT, that aggregated values of a given condition (i) have statistically trended in only one direction over the specified time period, and (ii) are currently over a specified threshold value; classifying, by the OLT, a given ONU from among the ONUs as a candidate rogue ONU that is qualified for further analysis based on the determination that the aggregated values of the given ONU (i) have statistically trended in only one direction over the specified time period, and (ii) are currently over the specified threshold value; and triggering, by the OLT, a discovery process that further analyzes the candidate rogue ONU based on the classification.

One example computer-implemented method includes determining, by an optical line terminal (OLT), that a bit-interleaved parity (BIP) error count of a passive optical network (PON) is currently over a PON BIP error threshold value, the PON including optical networking units (ONUs) actively transmitting over the PON; aggregating, by the OLT, BIP error counts and loss of frame (LOF) counts for each ONU among the ONUs based on the determination that the BIP error count of the PON is currently over the PON BIP error threshold value; determining, by the OLT, that at least one of (i) the BIP error count of at least one ONU among ONUs is currently over an ONU BIP error threshold value, or (ii) the LOF count of the at least one ONU among ONUs is currently over a ONU LOF threshold value; classifying, by the OLT, that at least one ONU from among the ONUs as a candidate rogue ONU that is qualified for further analysis based on the determination that at least one of (i) the BIP error count of the at least one ONU among ONUs is currently over the ONU BIP error threshold value, or (ii) the LOF count of at least one ONU among ONUs is currently over the ONU LOF threshold value, and triggering, by the OLT, a discovery process that further analyzes the candidate rogue ONU based on the classification.

One example computer-implemented method includes aggregating, by an optical line terminal (OLT) and over a specified time period, optical signal strengths values for optical networking units (ONUs) actively transmitting over a passive optical network (PON); determining, by the OLT, that at least one of the optical signal strengths values of at least one ONU among the ONUs has increased over a optical signal strength threshold value; classifying, by the OLT, the at least one ONU from among the ONUs as a candidate rogue ONU that is qualified for further analysis based on the determination that the optical signal strengths values of the at least one ONU among the ONUs has increased over the optical signal strength threshold value; and triggering, by the OLT, a discovery process that further analyzes the candidate rogue ONU based on the classification.

One example computer-implemented method includes determining, by an optical line terminal (OLT), operating state values of optical networking units (ONUs) actively transmitting over a passive optical network (PON); determining, by the OLT, that of at least one operating state value of at least one ONU among the ONUs is over an operating threshold value; classifying, by the OLT, the at least one ONU from among the ONUs as a candidate rogue ONU that is qualified for further analysis based on the determination that the operating state value of the at least one ONU among the ONUs is over the operating threshold value; and triggering, by the OLT, a discovery process that further analyzes the candidate rogue ONU based on the classification.

One example computer-implemented method includes determining, by an optical line terminal (OLT), a state of optical networking units (ONUs) actively transmitting over a passive optical network (PON); determining, by the OLT, that the state of each ONUs among the ONUs is down; disabling, by the OLT, ONU discovery based on determining that each ONUs among the ONUs is down; detecting, by the OLT, an optical signal from at least one ONU among the ONUs; classifying, by the OLT, that at least one ONU from among the ONUs as a candidate rogue ONU that is qualified for further analysis based on detecting the optical signal from the at least one ONU among the ONU; and triggering, by the OLT, a discovery process that further analyzes the candidate rogue ONU based on the classification.

One example computer-implemented method includes determining, by an optical line terminal (OLT), a plurality of optical networking units (ONUs) actively transmitting over a passive optical network (PON); disabling, by the OLT, all of the plurality of ONUs on the PON; monitoring, by the OLT, the PON to detect any optical signal; in response to not detecting any optical signal, sequentially enabling and then disabling, by the OLT, each ONU of the plurality of ONUs on the PON one at a time; monitroing, by the OLT, for any optical signal detected outside of an expected transmission timeslot for the enabled ONU; and in response to detecting any optical signal outside of the expected transmission timeslot, classifying, by the OLT, the enabled ONU as a candidate rogue ONU that is qualified for further analysis.

These and other implementations can each optionally include one or more of the following features. In some aspects, classifying the given ONU from among the ONUs as the candidate rogue ONU includes determining that the aggregated values of the given condition are over the specified threshold value after an integration time period after the given ONU from among the ONUs is classified as the candidate rogue ONU.

In some aspects, the aggregated values of the given condition include a periodic ranging adjustment count (PRAC) of the given ONU.

In some aspects, the candidate rogue ONU is one of a plurality of candidate rogue ONUs that are qualified for further analysis; and triggering the discovery process includes further analyzing the plurality of candidate rogue ONUs.

In some aspects, classifying the given ONU from among the ONUs as the candidate rogue ONU includes: determining that a bit-interleaved parity (BIP) error count of the PON is currently over a PON BIP error threshold value; aggregating BIP error counts and loss of frame (LOF) counts for each ONU among the ONUs based on the determination that the BIP error count of the PON is currently over the PON BIP error threshold value; determining that at least one of (i) the BIP error count of at least one ONU among ONUs is currently over an ONU BIP error threshold value, or (ii) the LOF count of the at least one ONU among ONUs is currently over a ONU LOF threshold value; and classifying that at least one ONU from among the ONUs as a second of the plurality of candidate rogue ONU that are qualified for further analysis based on the determination that at least one of (i) the BIP error count of the at least one ONU among ONUs is currently over the ONU BIP error threshold value, or (ii) the LOF count of at least one ONU among ONUs is currently over the ONU LOF threshold value.

In some aspects, classifying the given ONU from among the ONUs as the candidate rogue ONU includes: aggregating, over a second time period, optical signal strengths values for each ONU among the ONUs; determining that at least one of the optical signal strengths values of at least one ONU among the ONUs has increased over a optical signal strength threshold value; and classifying the at least one ONU from among the ONUs as a second of the plurality of candidate rogue ONU that are qualified for further analysis based on the determination that the optical signal strengths values of the at least one ONU among the ONUs has increased over the optical signal strength threshold value.

In some aspects, the optical signal strengths values for each ONU among the ONUs include at least one of a maximum received signal strength indicator (RSSI), a minimum RSSI, and an average RSSI.

In some aspects, classifying the given ONU from among the ONUs as the candidate rogue ONU includes: determining that an operating state value of at least one ONU among the ONUs is over an operating threshold value; and classifying the at least one ONU from among the ONUs as a second of the plurality of candidate rogue ONU that are qualified for further analysis based on the determination that the operating state value of the at least one ONU among the ONUs is over the operating threshold value.

In some aspects, the operating state value includes at least one of temperature, voltage, or bias current.

In some aspects, classifying the given ONU from among the ONUs as the candidate rogue ONU includes: determining that each ONUs among the ONUs is down; disabling ONU discovery based on determining that each ONUs among the ONUs is down; detecting an optical signal from at least one ONU among the ONUs; and classifying that at least one ONU from among the ONUs as a second of the plurality of candidate rogue ONU that are qualified for further analysis based on detecting the optical signal from the at least one ONU among the ONU.

In some aspects, the ONU discovery process includes searching the PON for the at least one candidate rogue ONU.

Some aspects include, in response to detecting any optical signal, sequentially disconnecting and then reconnecting each ONU of the plurality of ONUs on the PON one at a time; detecting an optical signal from at least one ONU among the plurality of ONUs on the PON; and classifying the at least one ONU from among the plurality of ONUs as a candidate rogue ONU that is qualified for further analysis based on detecting the optical signal from the at least one ONU among the plurality of ONUs.

In some aspects, methods can include the operations of determining, by an optical line terminal (OLT), that a bit-interleaved parity (BIP) error count of a passive optical network (PON) is currently over a PON BIP error threshold value, the PON including optical networking units (ONUs) actively transmitting over the PON; aggregating, by the OLT, BIP error counts and loss of frame (LOF) counts for each ONU among the ONUs based on the determination that the BIP error count of the PON is currently over the PON BIP error threshold value; determining, by the OLT, that at least one of (i) the BIP error count of at least one ONU among ONUs is currently over an ONU BIP error threshold value, or (ii) the LOF count of the at least one ONU among ONUs is currently over a ONU LOF threshold value; classifying, by the OLT, that at least one ONU from among the ONUs as a candidate rogue ONU that is qualified for further analysis based on the determination that at least one of (i) the BIP error count of the at least one ONU among ONUs is currently over the ONU BIP error threshold value, or (ii) the LOF count of at least one ONU among ONUs is currently over the ONU LOF threshold value, and triggering, by the OLT, a discovery process that further analyzes the candidate rogue ONU based on the classification.

In some aspects, methods can include the operations of aggregating, by an optical line terminal (OLT) and over a specified time period, optical signal strengths values for optical networking units (ONUs) actively transmitting over a passive optical network (PON); determining, by the OLT, that at least one of the optical signal strengths values of at least one ONU among the ONUs has increased over a optical signal strength threshold value; classifying, by the OLT, the at least one ONU from among the ONUs as a candidate rogue ONU that is qualified for further analysis based on the determination that the optical signal strengths values of the at least one ONU among the ONUs has increased over the optical signal strength threshold value; and triggering, by the OLT, a discovery process that further analyzes the candidate rogue ONU based on the classification.

In some aspects methods can include determining, by an optical line terminal (OLT), operating state values of optical networking units (ONUs) actively transmitting over a passive optical network (PON); determining, by the OLT, that of at least one operating state value of at least one ONU among the ONUs is over an operating threshold value; classifying, by the OLT, the at least one ONU from among the ONUs as a candidate rogue ONU that is qualified for further analysis based on the determination that the operating state value of the at least one ONU among the ONUs is over the operating threshold value; and triggering, by the OLT, a discovery process that further analyzes the candidate rogue ONU based on the classification.

In some aspect, methods can include determining, by an optical line terminal (OLT), a state of optical networking units (ONUs) actively transmitting over a passive optical network (PON); determining, by the OLT, that the state of each ONUs among the ONUs is down; disabling, by the OLT, ONU discovery based on determining that each ONUs among the ONUs is down; detecting, by the OLT, an optical signal from at least one ONU among the ONUs; classifying, by the OLT, that at least one ONU from among the ONUs as a candidate rogue ONU that is qualified for further analysis based on detecting the optical signal from the at least one ONU among the ONU; and triggering, by the OLT, a discovery process that further analyzes the candidate rogue ONU based on the classification.

In some aspects, methods can include determining, by an optical line terminal (OLT), a plurality of optical networking units (ONUs) actively transmitting over a passive optical network (PON); disabling, by the OLT, all of the plurality of ONUs on the PON; monitoring, by the OLT, the PON to detect any optical signal; in response to not detecting any optical signal, sequentially enabling and then disabling, by the OLT, each ONU of the plurality of ONUs on the PON one at a time monitoring, by the OLT, for any optical signal detected outside of an expected transmission timeslot for the enabled ONU; and in response to detecting any optical signal outside of the expected transmission timeslot, classifying, by the OLT, the enabled ONU as a candidate rogue ONU that is qualified for further analysis.

Methods can further include in response to detecting any optical signal, sequentially disconnecting and then reconnecting each ONU of the plurality of ONUs on the PON one at a time; detecting an optical signal from at least one ONU among the plurality of ONUs on the PON; and classifying the at least one ONU from among the plurality of ONUs as a candidate rogue ONU that is qualified for further analysis based on detecting the optical signal from the at least one ONU among the plurality of ONUs.

Particular embodiments of the subject matter described in this specification can be implemented so as to realize one or more of the following advantages. OLT hardware and/or software can detect and notify candidate rogue ONUs before errors occur on the PON. The candidate rogue ONUs can be analyzed and corrected before alarms manifest in order to prevent or reduce network downtime. Candidate rogue ONUs (e.g., potentially rogue ONUs) can be identified before conditions on the ONU reach an alarm level at which existing network alarms will be triggered, thereby enabling rogue ONUs to be identified before network conditions reach an alarm state. Early detection of rogue ONUs reduces network outages and/or reduced network bandwidth that can be caused by rogue ONUs. The candidate rogue ONUs can be detected without manual intervention. No modification to ONU hardware and/or software is needed, such that the methods, devices, and systems described in the present disclosure can be implemented with currently deployed ONUs. The speed and efficiency of detecting candidate rogue ONUs can be increased by analyzing a combination of factors which indicate that an ONU may enter a rogue state.

While some aspects of this disclosure generally describe computer-implemented software embodied on tangible media that processes and transforms data, some or all of the aspects may be computer-implemented methods or further included in respective systems or devices for performing the described functionality. The details of one or more embodiments of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example optical networking environment in which candidate rogue ONU(s) can be detected and/or identified.

FIG. 2 is a block diagram of an example OLT.

FIG. 3 is a flow chart of an example process for analyzing PRACs on a PON.

FIG. 4 is a flow chart of an example process for analyzing bit-interleaved parity (BIP) error counters on a PON FIG. 5 is a flow chart of an example process for analyzing RSSIs on a PON.

FIG. 6 is a flow chart of an example process for analyzing optics data for ONUs on a PON.

FIG. 7 is a flow chart of an example process for ONU signature detection.

FIG. 8 is a flow chart of an example process for detecting candidate rogue ONUs.

FIG. 9 is a flow chart of an example process for searching for rogue ONUs.

### DETAILED DESCRIPTION

The present disclosure describes methods, systems, and apparatus for detecting a candidate rogue Optical Networking Unit (ONU) on a passive optical network (PON). A Rogue ONU is an ONU that transmit outside of its allocated timeslot on a PON. In other words, a rogue ONU degrades or interferes with transmissions of other ONUs on the PON. However, the rogue ONU may itself be communicating without reporting errors, such that the identity of the rogue ONU can be difficult to determine.

An Optical Line Terminal (OLT) can monitor multiple network conditions in order to determine if the PON is in a rogue state or could potentially enter into a rogue state (e.g., a state in which a rogue ONU is transmitting over the PON). For example, the OLT can aggregate values of multiple network conditions of the PON over time and detect/identify the presence of rogue ONUs based on whether values of any of the network conditions exceed corresponding threshold values over a given period of time, as discussed in more detail below. When the OLT detects/identifies the presence of rogue ONU, the OLT can trigger a discovery process to further analyze the candidate rogue ONU. The discovery process can include performing remedial actions to prevent errors on the PON.

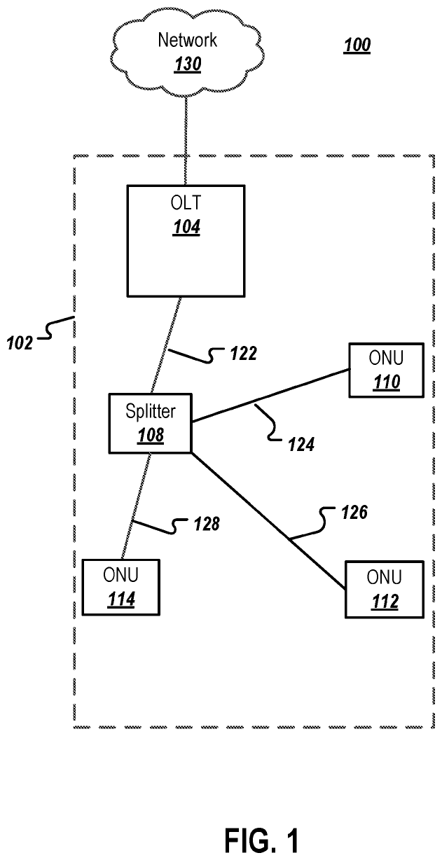

FIG. 1 is a block diagram illustrating an example optical networking environment 100 in which candidate rogue ONU(s) can be detected and/or identified. As illustrated in FIG. 1, the environment 100 includes a passive optical network (PON) 102 that connects users to a network 130. In some implementations, the environment 100 may include additional and/or different components not shown in the block diagram, such as one or more active optical networks (AONs), another type of network that provides network services (e.g., ADSL2+, VDSL2, etc.), or a combination of these and other technologies. In some implementations, components may also be omitted from the environment 100. In some implementations, the environment 100 can include redundant and non-redundant interconnections between the components shown in the block diagram and/or additional components not shown in the block diagram.

The network 130 facilitates wireless or wireline communications between the components of the PON 102 with any other local or remote computer, such as additional PONs, servers, or other devices communicably coupled to the network 130, including those not illustrated in FIG. 1. As illustrated in FIG. 1, the network 130 is depicted as a single network, but may be a combination of more than one network without departing from the scope of this disclosure.

In some implementations, one or more of the illustrated components may be included within network 130 as one or more cloud-based services or operations. The network 130 may be all or a portion of an enterprise or secured network, while in another case, at least a portion of the network 130 may represent a connection to the Internet, a public switched telephone network (PSTN), a data server, a video server, or additional or different networks. In some implementations, a portion of the network 130 may be a virtual private network (VPN). Further, all or a portion of the network 130 can comprise either a wireline or wireless link. Example wireless links may include 802.11ac/ad/af/ax/b/g/n, 802.20, WiMax, LTE, and/or any other appropriate wireless links. In other words, the network 130 encompasses any internal or external network, networks, sub-network, or combination thereof, operable to facilitate communications between various computing components, inside and outside the environment 100. The network 130 may communicate, for example, Internet Protocol (IP) packets, Frame Relay frames, Asynchronous Transfer Mode (ATM) cells, voice, video, data, and other suitable information between network addresses. The network 130 may also include one or more local area networks (LANs), radio access networks (RANs), metropolitan area networks (MANs), wide area networks (WANs), all or a portion of the Internet, and/or any other communication system or systems at one or more locations.

The PON 102 includes an OLT 104 (e.g., at a service provider's central office or other distribution point), a splitter 108, and ONUs 110, 112, and 114. Using the splitter 108, the OLT 104 is coupled to the ONUs 110, 112, and 114 (also referred to as optical network terminals (ONTs)), which are located near end users, thereby forming a point-to-multipoint network. For example, in the case of Gigabit Passive Optical Network (GPON), a single OLT port can connect to 64 (or another number of) different ONUs through the splitter 108. To serve multiple customers on the same network, the GPON uses logical multiplexing in a downstream direction and time-division multiplexing in an upstream direction. The PON 102 includes a link 122 connecting the OLT 104 and the splitter 108, a link 124 connecting the ONU 110 and the splitter 108, a link 126 connecting the ONU 112 and the splitter 108, and a link 128 connecting the ONU 114 and the splitter 108. In some examples, the links 122, 124, 126, and 128 are fiber optic links.

Each ONU can include, or otherwise be coupled to, one or more customer-premises equipment (CPE) or subscriber devices (e.g., CPE modems). For example, the ONU 110 is a device that terminates the PON 102 at the customer end, and provides a service connection to a user at a residential or commercial location. In some examples, the ONU 110 terminates optical fiber transmission, and can transform incoming optical signals into electrical signals, adapted for processing by subscriber devices. As a result, ONUs can provide network services, for example, to residential locations, business locations, or other forms of communications infrastructure, such as wireless communications equipment.

The OLT 104, as a network distribution element, provides an interface between the PON 102 and the network 130. The OLT 104 transmits downstream data traffic to the ONUs (e.g., ONUs 110, 112, and 114), and receives upstream data traffic from the ONUs. The OLT 104 aggregates values of multiple network conditions of the PON that includes the ONUs actively transmitting over the PON. The values of multiple network conditions can be monitored on link 122 over a specific time period. Different conditions can be monitored for different time periods.

The OLT 104 can determine if a value of any of the different conditions exceeds a threshold value, or otherwise falls outside of a specified range. If any values of conditions exceed a threshold value, or otherwise fall outside of a specified range, the OLT 104 can raise an alarm indicating that there is a candidate rogue ONU on the PON. The values of the multiple network conditions can be used as indications that there may be a problem on the PON and/or further analysis is required. In some implementations, the OLT 104 can raise an alarm based on a weighted combination of the values of the multiple network conditions. For example, more informative values can be assigned a higher weight. In some examples, periodic ranging adjustment counts (PRACs), bit interleave parity (BIP) error counts, and loss of frame (LOF) counts are more indicative of a rogue ONU than a received signal strength indicator (RSSI), ONU optical temperatures, and bias currents. In such examples, a weighted combination can include higher weights for the PRACs, BIP counts, and LOF counts, and lower weights for RSSI, ONU optical temperatures, and bias currents. In some examples, detecting a signal upstream while all ONUs are down and ONU discovery is turned off is highly indicative of a rogue ONU. In such examples, a weighted combination can include a highest weight for signals detected upstream. In some implementations, a weighted combination can be normalized to indicate a likelihood of a rogue ONU (e.g., an 80 percent chance of a rogue ONU).

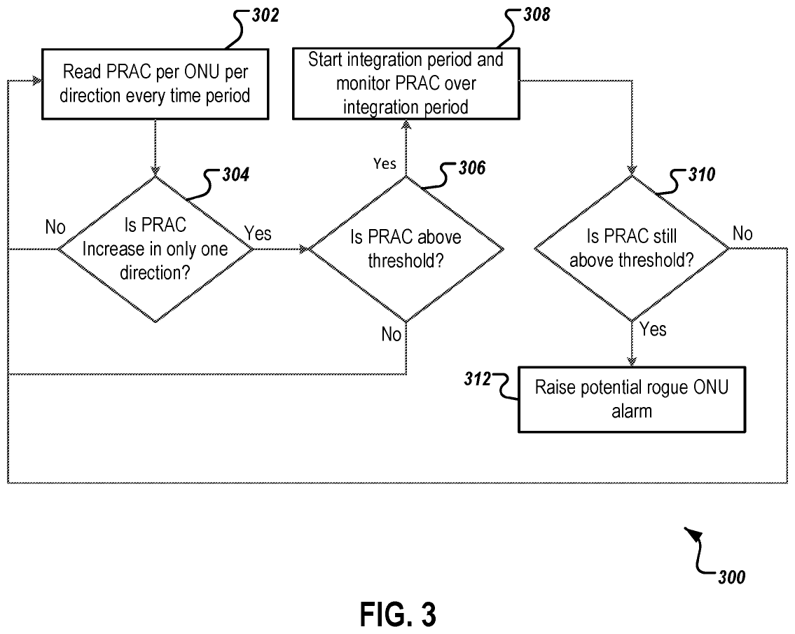

As discussed in detail with reference to FIGS. 3-7, the OLT 104 can use values of multiple network conditions on the link 122 to detect and/or identify a candidate rogue ONU. For example, the OLT can use processes 300, 400, 500, 600, or 700 to identify one or more candidate rogue ONUs. Timely identification of candidate rogue ONUs that are actual rogue ONUs can improve the performance of the PON because a rogue ONU may not cause any error conditions when enabled individually, but may cause error conditions on other ONUs of the PON (e.g., during time slots assigned to other ONUs), which degrades the performance of the PON. For example, ONU 112 could be a rogue ONU and transmit (e.g., broadcast a non-zero amount of optical power on a link) during the timeslots assigned to ONU 110, or other ONUs. In this example, the transmission of optical power by the ONU 112 during the timeslots of other ONUs can cause errors during the transmission of optical power by other ONUs, but will not negatively affect the transmissions of the ONU 112.

Transmitting during the timeslots of other ONUs is one example of an error that can be caused by a rogue ONU, but the rogue ONU may affect the values of multiple network conditions (e.g., PRAC, BIP error and LOF count, RSSI, SFP data, signal detection) monitored by the OLT 104. The OLT 104 can monitor values of the network conditions for one or more ONUs on a PON. A rogue ONU may cause a PRAC to increase in only one direction, BIP and LOF counts to increase, a max RSSI to increase, SFP values to increase, and/or a signal to be detected while all ONUs are down and ONU discovery is turned off or an ONU is detected transmitting in a wrong timeslot using a signal detect mechanism. As such, it may be possible to detect the presence of a rogue ONU (e.g., by way of the processes 300-700) on a PON, before the rogue ONU causes critical errors to any individual monitored network condition. In other words, the values of multiple network conditions can be used, either alone or in combination, to detect and/or assist in the detection of the candidate rogue ONU before critical network errors occur, and without taking the network offline. Furthermore, the OLT 104 can monitor the network conditions over a period of time to ensure that transient events (e.g., events that do not persist over a specified amount of time) do not result in an ONU being classified as a candidate rogue ONU.

As described in more detail below with reference to FIGS. 3-7, the classification of an ONU as a candidate rogue ONUs can be based on one or more of an upstream bandwidth map, periodic ranging adjustment counts (PRACs), bit interleave parity (BIP) counts, loss of frame (LOF) counts, burst mode receiver signal levels (RSSI), ONU optical temperatures, bias currents, or upstream signal detection counts. For example, if any of these network conditions moves outside of a specified acceptable range (e.g., passes a specified threshold) for a given ONU, the given ONU can be deemed a potentially rogue ONU, and classified as a candidate rogue ONU. In some situations, the out of range condition (e.g., over the specified threshold) must persist for a specified period of time before the PON is classified as having a potential candidate rogue ONU, but in other situations, the classification can be made upon first detecting the out of range condition.

A candidate rogue ONU that turns out to be a rogue ONU may be fixed, removed from the network, and/or replaced before causing more serious errors on the PON, thereby improving network performance and reliability. For example, when the OLT 104 classifies an ONU as a candidate rogue ONU, the OLT 104 can trigger a discovery process to further analyze the potentially detected rogue ONU, and determine whether that candidate rogue ONU is an actual rogue ONU. The discovery process can include searching the PON for at least one rogue ONU. For example, the OLT 104 can perform a linear search of each ONU on the PON sequentially. In some examples, the OLT 104 can perform a binary search of ONUs on the PON.

In some implementations, the OLT 104 can classify multiple ONUs as candidate rogue ONUs. A plurality of candidate rogue ONU can qualify for further analysis, and the OLT 104 can further analyze the plurality of candidate rogue ONUs during the discovery process. In some implementations, the OLT 104 can trigger a mitigation process based on detecting the candidate rogue ONU. For example, the OLT 104 can disable one or more candidate rogue ONUs that are deemed to be rogue ONUs following the performance of the discovery process.

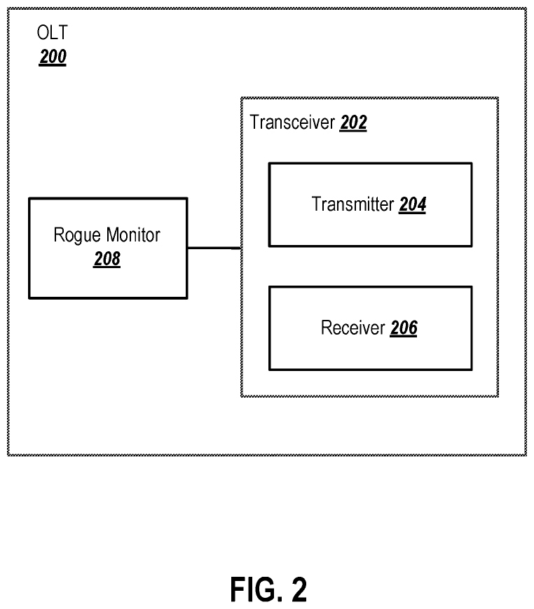

FIG. 2 is a block diagram of an example OLT 200. In some implementations, the OLT 200 may include additional and/or different components not shown in the block diagram. Components may also be omitted from the OLT transmitter 200. The components illustrated in FIG. 2 may be similar to or different from those described in FIG. 1.

As illustrated in FIG. 2, the OLT 200 includes a transceiver 202. The transceiver 202 can be configured to transmit and/or receive data streams from ONUs over a fiber optic link (e.g., the link 122). The transceiver 202 includes a transmitter 204 and a receiver 206. In some implementations, the transmitter 204 can transmit data streams to ONUs using logical multiplexing in a downstream direction. The receiver 206 can receive data streams from ONUs using time-division multiplexing in an upstream direction.

The OLT 200 includes a rogue monitor 208. The rogue monitor 208 includes one or more processors, and can be configured to detect and/or classify potentially rogue ONU(s) on a PON. The rogue monitor 208 can aggregate values of multiple network conditions of the PON. The rogue monitor 208 can measure or have access to communication parameters to detect error conditions and detect the candidate rogue ONU(s) on the PON. For example, the rogue monitor 208 can cooperate with the transceiver 202 to enable and disable ONUs on the PON.

In some implementations, the operations performed by the rogue monitor 208 can be implemented as operations performed by a data processing apparatus, on data stored on one or more computer-readable storage devices or received from other sources. The term “data processing apparatus” encompasses all kinds of apparatus, devices, and machines for processing data, including, by way of example, a programmable processor, a computer, a system on a chip, or multiple ones, or combinations of the foregoing. The rogue monitor 208 can also be implemented as special purpose logic circuitry, for example, an FPGA or an application specific integrated circuit (ASIC).

FIG. 3 is a flow chart of an example process 300 for analyzing periodic ranging adjustment counts (PRACs) on a PON. The example process 300 can be performed, for example, by one or more telecommunications devices, such as those described with reference to FIGS. 1 and 2 (e.g., an OLT that is the same or similar to OLT 104 or OLT 200). The example process 300 can also be implemented as instructions stored on a non-transitory computer-readable medium that, when executed by one or more telecommunications devices (or other data processing apparatus), cause the one or more telecommunications devices to perform the actions of the example process 300.

An OLT (e.g., an OLT that is the same or similar to OLT 104 or OTL 200) reads a PRAC for each ONU for each side of the adjustment direction (e.g., either early or late arrival of the ONU signal with respect to the OLT's expectation of the arrival time) over a specified time period (302). The OLT can read a PRAC during a time period, and compare the PRAC to past values. The OLT can determine whether an ONU is transmitting early or late using the arrival time of data at the OLT. Constant movement of the PRAC in one direction can be an indicator of a potentially rogue ONU. For example, a rogue ONU may transmit later and later over time, and cause the upstream PRAC for the ONU to increase over time. In such an example, the OLT can classify the ONU as a candidate rogue ONU. In some examples, cooling at night can cause a link between an ONU and the OLT to shorten, and warming during the day can cause the link between the ONU and the OLT to lengthen. In such an example, the PRACs for the ONU decrease at night and increase during the day. The OLT can determine that the ONU is not a candidate rogue ONU.

The PRACs can be one of multiple network conditions on the PON that are monitored by the OLT, and for which values are aggregated by the OLT over the specified time period (e.g., 300 seconds or any other appropriate amount of time). For example, the OLT can monitor values corresponding to PRACs, BIP errors, RSSIs, small form factor pluggable (SFP/SFF) data, and/or upstream signals. In some implementations, the OLT can aggregate values of the multiple network conditions for each direction (e.g., upstream and downstream) for each ONU. In some situations, the OLT can determine that aggregated values of a given condition have statistically trended in only one direction over the specified time period, and are currently over a specified threshold value, which can be an indication of a candidate rogue ONU.

The OLT determines whether each PRAC is increasing in only one direction (304). When the OLT determines that the PRAC is not increasing in only one direction over a given time period (e.g., the PRAC increases and decreases during the given time period), the process 300 follows the “No” branch and the OLT continues to read the PRACs over additional (e.g., subsequent) time periods (302). For example, the PRAC can move in both directions as a fiber optic cable connecting the OLT to an ONU expands or shrinks (e.g., based on temperature), or other conditions change over time. These variations generally would not be attributable to a potentially rogue ONU, whereas a continuing change in one direction can be indicative of a potentially rogue ONU on a PON. In some implementations, the Periodic Ranging Adjustment Algorithm adjusts (e.g., centers) ONUs transmission to account for small temporal changes in upstream transmission. However, if the PRAC continues to change in one direction, the adjustments may not be able to continue to center the PRAC.

When the OLT determines that the PRAC is increasing in only one direction in time (e.g., early, late), the process 300 follows the “Yes” branch to operation 306. For example, a fiber optic cable shouldn't always expand without shrinking, such that a continuing change to the PRAC in one direction may be indicative of a potentially rogue ONU on the PON.

The OLT determines whether the PRAC is above a threshold value (306). When the OLT determines that the PRAC is not above the threshold value, the process 300 follows the “No” branch and the OLT continues to read the PRACs over additional (e.g., subsequent) time periods (302). When the OLT determines that the PRAC is above the threshold value (e.g., the PRAC has increased in only one direction more than the threshold amount), the process 300 follows the “Yes” branch to operation 308. In some implementations, the OLT can determine a number of time periods (e.g., sequential time periods) the PRAC has increased in the one direction. In such implementations, the OLT can determine when the number of time periods is above a threshold value. In these implementations, continuing to operation 308 by way of the “Yes” branch can be conditioned on the number of time periods being above the threshold. In this way, the system can be tuned to account for temporary fluctuations above the PRAC threshold value that do not persist long enough to be attributable to a potentially rogue ONU.

The OLT starts an integration period and monitors the PRAC over the integration period (308). The OLT can use the integration period to determine whether the PRAC remains over the threshold value for a certain amount of time. For example, the PRAC may bounce above the threshold value, and return under the threshold value before the end of the integration period. In such an example, a minor blip down will not trigger the discovery process. In some implementations, the OLT can determine a trend by performing a linear regression of collected PRAC data. In some implementations, the OLT can average a moving window of PRAC values (e.g., last three values). In some implementations, the OLT can drop outliers (e.g., the first value in the opposite direction can be ignored).

The OLT determines whether the PRAC is above a threshold value after the integration period (310). When the OLT determines that the PRAC is not above the threshold value, the process 300 follows the “No” branch and the OLT continues to read the PRACs over additional (e.g., subsequent) time periods (302). When the OLT determines that the PRAC is above the threshold value, the process 300 follows the “Yes” branch.

The OLT raises a potential rogue ONU alarm (312). The OLT classifies a given ONU from among the ONUs actively transmitting over the PON as a candidate rogue ONU that is qualified for further analysis. The OLT classifies the candidate rogue ONU based on the determination that the aggregated values of the given ONU have statistically trended in only one direction over the specified time period and are currently over the specified threshold value. In some implementations, the OLT determines that the aggregated values of the given condition are over the specified threshold value after an integration time period after the given ONU from among the ONUs is classified as the candidate rogue ONU. The OLT can trigger a discovery process that further analyzes the candidate rogue ONU based on the classification.

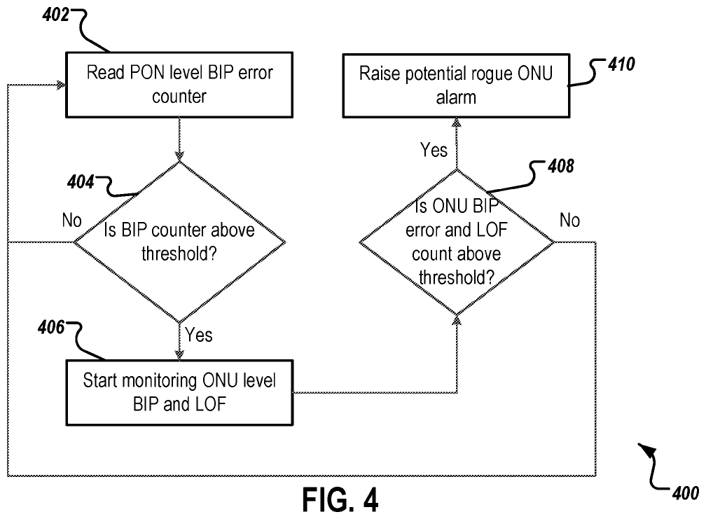

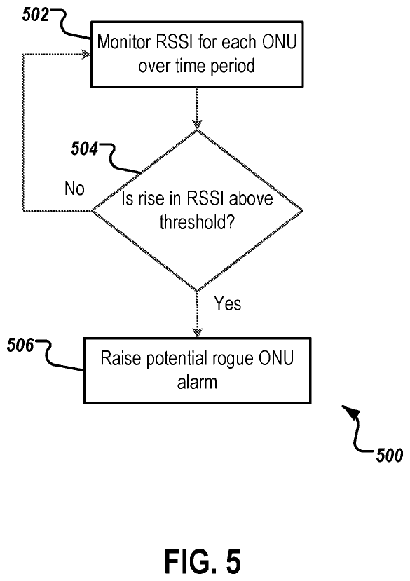

FIG. 4 is a flow chart of an example process 400 for analyzing bit-interleaved parity (BIP) error counters on a PON. The example process 400 can be performed, for example, by one or more telecommunications devices, such as those described with reference to FIGS. 1 and 2 (e.g., an OLT that is the same or similar to OLT 104 or OLT 200). The example process 400 can also be implemented as instructions stored on a non-transitory computer-readable medium that, when executed by one or more telecommunications devices (or other data processing apparatus), cause the one or more telecommunications devices to perform the actions of the example process 400.

An OLT (e.g., an OLT that is the same or similar to OLT 104 or OTL 200) reads a PON level BIP error counter (402). The BIP error counter can include a count of upstream frame BIP errors since the OLT started up. An error can be caused by interference during a transmission from an ONU. The OLT monitors a global error count for all ONUs on the PON.

The OLT determines whether the BIP error counter of the PON is currently over a PON BIP error threshold value (404). When the OLT determines that the BIP error counter is not above the threshold value, the process 400 follows the “No” branch and the OLT continues to read the PON level BIP error counter (402). This can save CPU time in comparison to always monitoring BIP error counts and LOF counts for each ONU on the PON because only one global error count is monitored until the threshold is exceeded.

When the OLT determines that the BIP counter is above the PON BIP error threshold value, the process 400 follows the “Yes” branch to operation 406.

The OLT can determine timeslots for when each ONU transmits. As such, the OLT can determine which ONU is affected by an error based on a time slot during which the error occurs. The OLT can shut down the affected ONU and determine whether there is still an error during the corresponding timeslot. If the OLT determines that there is still an error while the affected ONU is shut down, the OLT can determine that a rogue ONU may be causing the error on the affected ONU (e.g., the rogue ONU is transmitting during the timeslot of the affected ONU).

The OLT starts monitoring an ONU level BIP error count and a LOF count (406). In some implementations, the OLT can aggregate BIP error counts and LOF counts for each ONU among the ONUs on the PON based on the determination that the BIP error count of the PON is currently over the PON BIP error threshold value. In some implementations, the OLT can monitor a BIP error count and LOF count for each ONU on a PON (e.g., the OLT detects an error during the timeslot corresponding the ONU).

The OLT determines whether the ONU level BIP error count and the LOF count are above threshold values (408). The OLT can determine whether a BIP error count of at least one ONU on the PON is currently over an ONU BIP error threshold value, or whether the LOF count of at least one ONU is currently over an ONU LOF threshold value. When the OLT determines that the ONU level BIP error count and the LOF count are not above the threshold values, the process 400 follows the “No” branch and the OLT continues to read the PON level BIP error counter (402). When the OLT determines that at least one of the ONU level BIP error count or the LOF count are above the threshold values (e.g., when one of or both of the ONU level BIP error count and the LOF count are above respective threshold values), the process 400 follows the “Yes” branch to operation 410.

The OLT raises a potential rogue ONU alarm (410). In some implementations, the OLT can raise the potential rogue ONU alarm when both the ONU level BIP error count and the LOF count are above their respective threshold values. In some implementations, the OLT can raise the potential rogue ONU alarm when either the ONU level BIP error count or the LOF count is above a respective threshold value. The OLT can classify at least one ONU from among the ONUs on the PON as a candidate rogue ONU that is qualified for further analysis based on the determination that the at least one of the BIP error count of the at least one ONU is currently over the ONU BIP threshold value, or the LOF count of the at least one ONU is currently over the ONU LOF threshold value. A rogue ONU is an ONU that transmits optical signals outside of their allocated timeslot. Rogue ONU's optical transmission can overshoot an allocated timeslot (e.g., transmit after the end of the timeslot) or the rogue ONU can start transmitting earlier than it should. In both cases there is a greater possibility of rogue ONUs interfering with transmission with adjacent ONUs in bandwidth map. In the case of ONU overshooting transmission from allocated timeslot, the possibility of LOF declaration for the neighboring ONUs in bandwidth map is very high. ONUs starting the optical transmission earlier than allocated timeslot could lead to BIP error count increase in adjacent ONUs in bandwidth map. Combined and/or separate evaluation of both BIP error count and LOF count can lead to declaration of potential presence of rogue ONU on a PON FIG. 5 is a flow chart of an example process 500 for analyzing received signal strength indicators (RSSIs) on a PON. The example process 500 can be performed, for example, by one or more telecommunications devices, such as those described with reference to FIGS. 1 and 2 (e.g., an OLT that is the same or similar to OLT 104 or OLT 200). The example process 500 can also be implemented as instructions stored on a non-transitory computer-readable medium that, when executed by one or more telecommunications devices (or other data processing apparatus), cause the one or more telecommunications devices to perform the actions of the example process 500.

An OLT (e.g., an OLT that is the same or similar to OLT 104 or OTL 200) monitors a received signal strength indicator (RSSI) for each ONU over a time period (502). For example, the RSSI may be measured every 30 or 60 seconds (or another appropriate interval). In some examples, the time period may be five minutes, but other time periods can be used. An RSSI corresponds to optical power received at the OLT from a transmission from an ONU. Signal strengths values for ONUs can include a maximum RSSI, a minimum RSSI, and/or an average RSSI. In some implementations, the OLT can aggregate the RSSI for each ONU among the ONUs that are on the PON over the specified time period so that the RSSIs can be evaluated over time.

The OLT determines whether a rise in the RSSI is above a signal strength threshold value (504). The rise in the RSSI can correspond to an increase in the maximum RSSI, the minimum RSSI, and/or the average RSSI. In some implementations, the OLT can determine whether the maximum RSSI remains over the threshold value for the time period. In some implementations, the threshold value can be based on an average RSSI (e.g., for a given time period), and the OLT can determine whether the current RSSI is higher than the average RSSI. When the OLT determines that the rise in the RSSI is not above the threshold value, the process 500 follows the “No” branch and the OLT continues to monitor the RSSI for each ONU over the time period (502). When the OLT determines that the rise in the RSSI is above the threshold value, the process 500 follows the “Yes” branch to operation 506.

The OLT raises a potential rogue ONU alarm (506). The OLT can classify at least one ONU from among the multiple ONUs on the PON as a candidate rogue ONU that is qualified for further analysis based on the determination that the signal strengths values of the at least one ONU has increased over the signal strength threshold value.

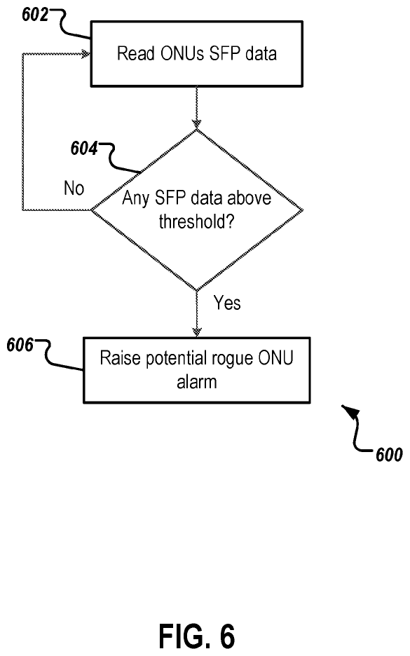

FIG. 6 is a flow chart of an example process 600 for analyzing optics data for ONUs on a PON. The example process 600 can be performed, for example, by one or more telecommunications devices, such as those described with reference to FIGS. 1 and 2 (e.g., an OLT that is the same or similar to OLT 104 or OTL 200). The example process 600 can also be implemented as instructions stored on a non-transitory computer-readable medium that, when executed by one or more telecommunications devices (or other data processing apparatus), cause the one or more telecommunications devices to perform the actions of the example process 600.

The optics data for ONUs can be read from small form factor pluggable (SFP), small form factor fixed (SFF), and/or discrete component optical transceivers. In some implementations, the ONU can report optical transceiver data to the OLT regardless of the physical arrangement of the ONU optical transceiver components.

An OLT (e.g., an OLT that is the same or similar to OLT 104 or OLT 200) reads SFP data for ONUs on a PON (602). SFP data can include operating state values of an ONU (e.g., optical temperature, bias current, and/or voltage data).

The OLT determines whether any SFP data for any ONU is above an operating threshold value (604). In some implementations, the operating threshold value includes, or is based on, an operating range for the ONU. In some implementations, the OLT can determine whether a combination of SFP data is over a combined operating threshold value. When the OLT determines that no SFP data is above the threshold value, the process 600 follows the “No” branch and the OLT continues to monitor the RSSI for each ONU over the time period (602). When the OLT determines that any SFP data is above the threshold value, the process 600 follows the “Yes” branch to operation 606.

The OLT raises a potential rogue ONU alarm (606). SFP data can be used as an early detection signal that an error is about to happen. If SFP data exceeds a limit, the ONU can enter a rogue state. Therefore, SFP data can be monitored to raise an alarm before the ONU enters a rogue state. The OLT can classify at least one ONU as a candidate rogue ONU that is qualified for further analysis based on the determination that the operating state value of the at least one ONU is over the operating threshold value.

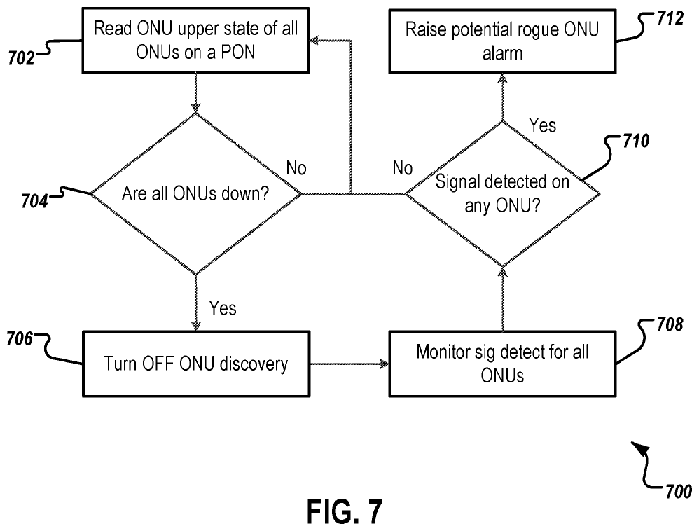

FIG. 7 is a flow chart of an example process 700 for ONU transmit signal detection. The example process 700 can be performed, for example, by one or more telecommunications devices, such as those described with reference to FIGS. 1 and 2 (e.g., an OLT that is the same or similar to OLT 104 or OLT 200). The example process 700 can also be implemented as instructions stored on a non-transitory computer-readable medium that, when executed by one or more telecommunications devices (or other data processing apparatus), cause the one or more telecommunications devices to perform the actions of the example process 700.

An OLT (e.g., an OLT that is the same or similar to OLT 104 or OTL 200) reads an ONU upper state of all (or a subset of) ONUs on a PON (702). The OLT sends timeslots for each ONU downstream for every frame. The timeslots create an upstream bandwidth map (US bwmap) for the ONUs on the PON. Each ONU should only transmit during its assigned timeslots.

The OLT determines whether all ONUs are down (704). When the OLT determines that all ONUs are not down, the process 700 follows the “No” branch and the OLT continues to read an ONU upper state of all ONUs on a PON (702). When the OLT determines that any of the ONUs are up, the condition for determining potentially rogue ONUs will not trigger. When the OLT determines that all ONUs are down, the process 700 follows the “Yes” branch to operation 706.

The OLT turns off ONU discovery (706). The OLT disables ONU discovery based on determining that each ONUs among the ONUs is down. ONU discovery is how the OLT discovers ONUs on the PON and requires transmissions between the OLT and unregistered ONUs. For example, during discovery, unregistered ONUs broadcast signals on the PON. When each ONU is down and ONU discovery is turned off, no ONUs should be broadcasting any signals on the PON. Any signal detected by the OLT can be an indication of a candidate rogue ONU.

The OLT monitors signal detect for all ONUs on the PON (708). While all the ONUs are down and ONU discovery is turned off, none of the ONUs should be transmitting. The ONUs should only transmit when instructed to by the OLT.

The OLT determines whether a signal is detected from any ONU (710). When no signal is detected on any ONU by the OLT, the process 700 follows the “No” branch and the OLT continues to read an ONU upper state of all ONUs on a PON (702). When a signal is detected on any ONU by the OLT, the process 700 follows the “Yes” branch to operation 712.

The OLT raises a potential rogue ONU alarm (712). A detected signal indicates that the laser of at least one ONU is staying on. The OLT can classify at least one ONU as a candidate rogue ONU that is qualified for further analysis based on detecting the signal on the at least one ONU.

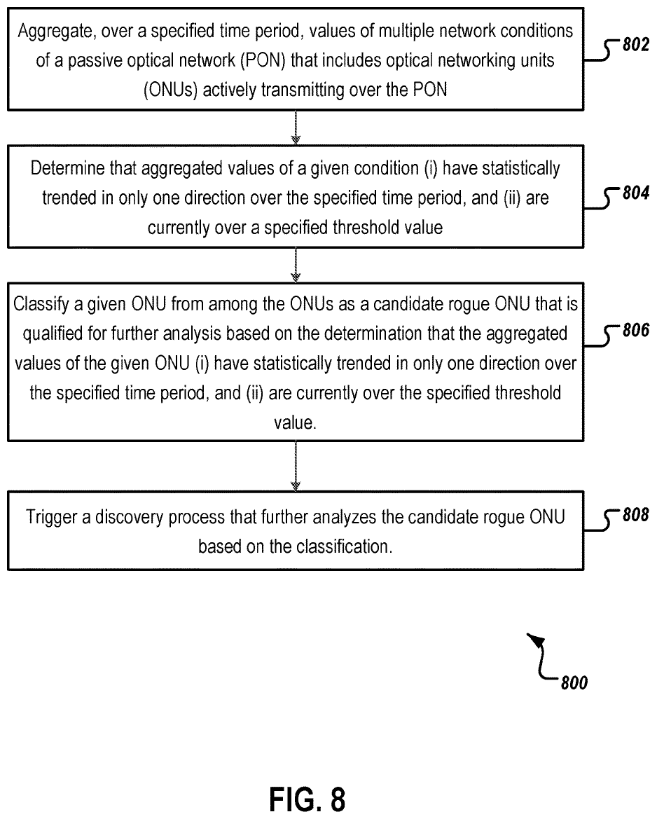

FIG. 8 is a flow chart of an example process 800 for detecting candidate rogue ONUs. The example process 800 can be performed, for example, by one or more telecommunications devices, such as those described with reference to FIGS. 1 and 2 (e.g., an OLT that is the same or similar to OLT 104 or OTL 200). The example process 800 can also be implemented as instructions stored on a non-transitory computer-readable medium that, when executed by one or more telecommunications devices (or other data processing apparatus), cause the one or more telecommunications devices to perform the actions of the example process 800.

The OLT aggregates, over a specified time period, values of multiple network conditions of a passive optical network (PON) that includes optical networking units (ONUs) actively transmitting over the PON (802). In some implementations, the aggregation of multiple network conditions can include aggregation of various indicators, such as those discussed with respect to FIGS. 3-7). For example, the aggregation can include an aggregation of one or more of PRACs, BIP errors and/or LOF errors, RSSIs, SFP data, or upper state information.

The OLT determines that aggregated values of a given condition (i) have statistically trended in only one direction over the specified time period, and (ii) are currently over a specified threshold value (804). For example, as discussed above, the OLT can use the aggregated values to determine when the PRACs for an ONU have only increased (or decreased) over a specified amount of time. Similarly, the OLT could determine that other signals have only increased or decreased over the specified time period.

The OLT classifies a given ONU from among the ONUs as a candidate rogue ONU that is qualified for further analysis based on the determination that the aggregated values of the given ONU (i) have statistically trended in only one direction over the specified time period, and (ii) are currently over the specified threshold value (806). In some implementations, the determination that the aggregated values are currently over the specified threshold value is a final check to ensure that the condition has not corrected itself due to a network or an environmental change that caused the value to return to an acceptable range.

The OLT triggers a discovery process that further analyzes the candidate rogue ONU based on the classification (808). For example, as discussed above, the OLT can use the discovery process to determine whether the candidate rogue ONU is actually a rogue ONU.

The example process 800 shown in FIG. 8 can be modified or reconfigured to include additional, fewer, or different actions (not shown in FIG. 8), which can be performed in the order shown or in a different order. In some implementations, one or more of the actions can be repeated or iterated, for example, until a terminating condition is reached. In some implementations, one or more of the individual actions shown in FIG. 8 can be executed as multiple separate actions, or one or more subsets of the actions shown in FIG. 8 can be combined and executed as a single action.

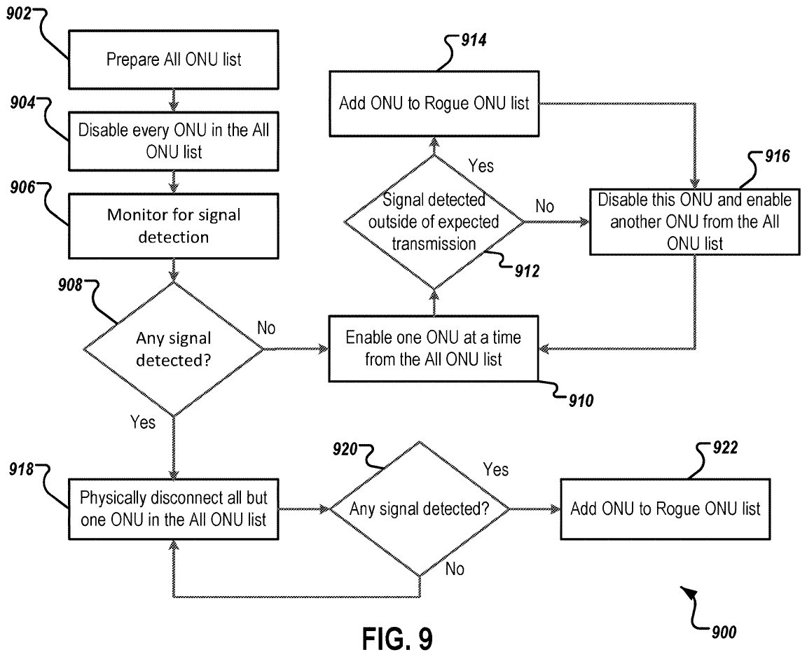

FIG. 9 is a flow chart of an example process 900 for searching for rogue ONUs. The example process 900 can be performed, for example, by one or more telecommunications devices, such as those described with reference to FIGS. 1 and 2 (e.g., an OLT that is the same or similar to OLT 104 or OLT 200). The example process 900 can also be implemented as instructions stored on a non-transitory computer-readable medium that, when executed by one or more telecommunications devices (or other data processing apparatus), cause the one or more telecommunications devices to perform the actions of the example process 900.

An OLT (e.g., an OLT that is the same or similar to OLT 104 or OTL 200) prepares a list (All ONU list) of all the ONUs connected on a PON (902). For example, the OLT can determine all of the ONUs which connect to a wider network through the OLT. In such an example, the wider network can include a network that is that same or similar to network 130.

The OLT disables every ONU in the All ONU list (904). For example, the OLT can send instructions to the ONUs through a fiber optic link to disable the ONUs that are included in the all ONU list.

The OLT monitors the PON for signal detection (906). While all the ONUs in the All ONU list are disabled and ONU discovery is turned off, none of the ONUs should be transmitting. Thus, the OLT can monitor for any signals on the PON since no ONUs should be transmitting on the PON, and detection of a signal would be an indication of a potential problem on the PON.

The OLT determines whether any signal is detected on the PON from any ONU (908). For example, if the OLT detects any signal at a receiver, the OLT can determine that a signal from an ONU has been detected. If the OLT does not detect any signal at the receiver, the OLT can determine that no ONU signals have been detected.

In response to determining that no signal is detected on the PON from any ONU by the OLT, the OLT enables each ONU in the All ONU list one at a time (910).

For example, all of the ONUs on the PON can be enabled individually while all other ONUs remain disabled. The OLT can then determine whether any ONUs are transmitting in a wrong timeslot.

The OLT determines whether any signal is detected outside of an expected transmission timeslot for the enabled ONU (912). For example, the OLT can assign transmission timeslots to all the ONUs on the PON. If a signal from one of the ONUs is received at the OLT outside of its assigned timeslot, the OLT can determine that ONU is transmitting outside of its expected transmission timeslot.

In response to determining that a signal is detected outside of an expected transmission timeslot for the enabled ONU, the OLT adds the enabled ONU to a rogue ONU list (e.g., a suspect rogue ONU list) (914). For example, the OLT can determine that the enabled ONU transmitted outside of its assigned transmission timeslot. The OLT can classify one or more of the ONUs in the All ONU list as a set of suspect ONUs.

The OLT disables the currently enabled ONU, and enables another ONU from the All ONU list (916). The OLT enables one ONU at a time until all the ONUs in the All ONU list have been enabled.

In response to determining that a signal is detected on any ONU by the OLT (908), all but one ONU in the All ONU list can be physically disconnected from the PON one at a time (918).

The OLT determines whether any signal is detected on the PON (920).

In response to determining that no signal is detected from any ONU by the OLT, the connected ONU is disconnected, and another ONU from the All ONU list is connected to the PON, such that all but one ONU in the All ONU list are again disconnected (918), and the determination can again be made whether any signal is detected on the PON (920).

In response to determining that a signal is detected on the PON at 920, the OLT, adds the connected ONU to a rogue ONU list (e.g., a suspect rogue ONU list) (922). For example, the OLT can determine that the connected ONU is always transmitting, and therefore, a suspect rogue ONU.

The OLT can raise an alarm for each ONU in the Rogue ONU List, and/or disable or disconnect all ONUs in the Rogue ONU List. The OLT can run a rogue ONU detection process until the Rogue ONU list is empty.

In some implementations, methods can include the operations of determining, by an optical line terminal (OLT), that a bit-interleaved parity (BIP) error count of a passive optical network (PON) is currently over a PON BIP error threshold value, the PON including optical networking units (ONUs) actively transmitting over the PON; aggregating, by the OLT, BIP error counts and loss of frame (LOF) counts for each ONU among the ONUs based on the determination that the BIP error count of the PON is currently over the PON BIP error threshold value; determining, by the OLT, that at least one of (i) the BIP error count of at least one ONU among ONUs is currently over an ONU BIP error threshold value, or (ii) the LOF count of the at least one ONU among ONUs is currently over a ONU LOF threshold value; classifying, by the OLT, that at least one ONU from among the ONUs as a candidate rogue ONU that is qualified for further analysis based on the determination that at least one of (i) the BIP error count of the at least one ONU among ONUs is currently over the ONU BIP error threshold value, or (ii) the LOF count of at least one ONU among ONUs is currently over the ONU LOF threshold value, and triggering, by the OLT, a discovery process that further analyzes the candidate rogue ONU based on the classification.

In some implementations, methods can include the operations of aggregating, by an optical line terminal (OLT) and over a specified time period, optical signal strengths values for optical networking units (ONUs) actively transmitting over a passive optical network (PON); determining, by the OLT, that at least one of the optical signal strengths values of at least one ONU among the ONUs has increased over a optical signal strength threshold value; classifying, by the OLT, the at least one ONU from among the ONUs as a candidate rogue ONU that is qualified for further analysis based on the determination that the optical signal strengths values of the at least one ONU among the ONUs has increased over the optical signal strength threshold value; and triggering, by the OLT, a discovery process that further analyzes the candidate rogue ONU based on the classification.

In some implementations methods can include determining, by an optical line terminal (OLT), operating state values of optical networking units (ONUs) actively transmitting over a passive optical network (PON); determining, by the OLT, that of at least one operating state value of at least one ONU among the ONUs is over an operating threshold value; classifying, by the OLT, the at least one ONU from among the ONUs as a candidate rogue ONU that is qualified for further analysis based on the determination that the operating state value of the at least one ONU among the ONUs is over the operating threshold value; and triggering, by the OLT, a discovery process that further analyzes the candidate rogue ONU based on the classification.

In some implementations, methods can include determining, by an optical line terminal (OLT), a state of optical networking units (ONUs) actively transmitting over a passive optical network (PON); determining, by the OLT, that the state of each ONUs among the ONUs is down; disabling, by the OLT, ONU discovery based on determining that each ONUs among the ONUs is down; detecting, by the OLT, an optical signal from at least one ONU among the ONUs; classifying, by the OLT, that at least one ONU from among the ONUs as a candidate rogue ONU that is qualified for further analysis based on detecting the optical signal from the at least one ONU among the ONU; and triggering, by the OLT, a discovery process that further analyzes the candidate rogue ONU based on the classification.

In some implementations, methods can include determining, by an optical line terminal (OLT), a plurality of optical networking units (ONUs) actively transmitting over a passive optical network (PON); disabling, by the OLT, all of the plurality of ONUs on the PON; monitoring, by the OLT, the PON to detect any optical signal; in response to not detecting any optical signal, sequentially enabling and then disabling, by the OLT, each ONU of the plurality of ONUs on the PON one at a time monitoring, by the OLT, for any optical signal detected outside of an expected transmission timeslot for the enabled ONU; and in response to detecting any optical signal outside of the expected transmission timeslot, classifying, by the OLT, the enabled ONU as a candidate rogue ONU that is qualified for further analysis.

Methods can further include in response to detecting any optical signal, sequentially disconnecting and then reconnecting each ONU of the plurality of ONUs on the PON one at a time; detecting an optical signal from at least one ONU among the plurality of ONUs on the PON; and classifying the at least one ONU from among the plurality of ONUs as a candidate rogue ONU that is qualified for further analysis based on detecting the optical signal from the at least one ONU among the plurality of ONUs.

While this specification contains many specific implementation details, these should not be construed as limitations on the scope of any inventions or of what may be claimed, but rather as descriptions of features specific to particular embodiments of particular inventions. Certain features that are described in this specification, in the context of separate embodiments, can also be implemented in combination or in a single embodiment. Conversely, various features that are described in the context of a single embodiment can also be implemented in multiple embodiments, separately, or in any suitable subcombination. Moreover, although features may be described above as acting in certain combinations and even initially claimed as such, one or more features from a claimed combination can in some cases be excised from the combination, and the claimed combination may be directed to a subcombination, or variation of a subcombination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A method, comprising:
aggregating, by an optical line terminal (OLT) and over a specified time period, values of multiple network conditions of a passive optical network (PON) that includes optical networking units (ONUs) actively transmitting over the PON;
determining, by the OLT, that aggregated values of a given condition (i) have statistically trended in only one direction over the specified time period, and (ii) are currently over a specified threshold value;
classifying, by the OLT, a given ONU from among the ONUs as a candidate rogue ONU that is qualified for further analysis based on the determination that the aggregated values of the given ONU (i) have statistically trended in only one direction over the specified time period, and (ii) are currently over the specified threshold value; and
triggering, by the OLT, a discovery process that further analyzes the candidate rogue ONU based on the classification.

2. The method of claim 1, wherein classifying the given ONU from among the ONUs as the candidate rogue ONU comprises determining that the aggregated values of the given condition are over the specified threshold value after an integration time period after the given ONU from among the ONUs is classified as the candidate rogue ONU.

3. The method of claim 1, wherein the aggregated values of the given condition comprise a periodic ranging adjustment count (PRAC) of the given ONU.

4. The method of claim 1, wherein:
the candidate rogue ONU is one of a plurality of candidate rogue ONUs that are qualified for further analysis; and
triggering the discovery process comprises further analyzing the plurality of candidate rogue ONUs.

5. The method of claim 4, wherein classifying the given ONU from among the ONUs as the candidate rogue ONU comprises:
determining that a bit-interleaved parity (BIP) error count of the PON is currently over a PON BIP error threshold value;
aggregating BIP error counts and loss of frame (LOF) counts for each ONU among the ONUs based on the determination that the BIP error count of the PON is currently over the PON BIP error threshold value;
determining that at least one of (i) the BIP error count of at least one ONU among ONUs is currently over an ONU BIP error threshold value, or (ii) the LOF count of the at least one ONU among ONUs is currently over a ONU LOF threshold value; and
classifying that at least one ONU from among the ONUs as a second of the plurality of candidate rogue ONU that are qualified for further analysis based on the determination that at least one of (i) the BIP error count of the at least one ONU among ONUs is currently over the ONU BIP error threshold value, or (ii) the LOF count of at least one ONU among ONUs is currently over the ONU LOF threshold value.

6. The method of claim 4, wherein classifying the given ONU from among the ONUs as the candidate rogue ONU comprises:
aggregating, over a second time period, optical signal strengths values for each ONU among the ONUs;
determining that at least one of the optical signal strengths values of at least one ONU among the ONUs has increased over a optical signal strength threshold value; and
classifying the at least one ONU from among the ONUs as a second of the plurality of candidate rogue ONU that are qualified for further analysis based on the determination that the optical signal strengths values of the at least one ONU among the ONUs has increased over the optical signal strength threshold value.

7. The method of claim 6, wherein the optical signal strengths values for each ONU among the ONUs comprise at least one of a maximum received signal strength indicator (RSSI), a minimum RSSI, and an average RSSI.

8. The method of claim 4, wherein classifying the given ONU from among the ONUs as the candidate rogue ONU comprises:
determining that an operating state value of at least one ONU among the ONUs is over an operating threshold value; and
classifying the at least one ONU from among the ONUs as a second of the plurality of candidate rogue ONU that are qualified for further analysis based on the determination that the operating state value of the at least one ONU among the ONUs is over the operating threshold value.

9. The method of claim 8, wherein the operating state value comprises at least one of temperature, voltage, or bias current.

10. The method of claim 4, wherein classifying the given ONU from among the ONUs as the candidate rogue ONU comprises:
determining that each ONUs among the ONUs is down;
disabling ONU discovery based on determining that each ONUs among the ONUs is down;
detecting an optical signal from at least one ONU among the ONUs; and
classifying that at least one ONU from among the ONUs as a second of the plurality of candidate rogue ONU that are qualified for further analysis based on detecting the optical signal from the at least one ONU among the ONU.

11. The method of claim 1, wherein the ONU discovery process comprises searching the PON for the at least one candidate rogue ONU.

12. A system, comprising:
a plurality of optical network units (ONUs) connected to a fiber optic link; and
an optical line terminal (OLT) connected to the fiber optic link, wherein the OLT comprises one or more processors configured to perform operations comprising:
aggregating, over a specified time period, values of multiple network conditions of a passive optical network (PON) that includes optical networking units (ONUs) actively transmitting over the PON;
determining that aggregated values of a given condition (i) have statistically trended in only one direction over the specified time period, and (ii) are currently over a specified threshold value;
classifying a given ONU from among the ONUs as a candidate rogue ONU that is qualified for further analysis based on the determination that the aggregated values of the given ONU (i) have statistically trended in only one direction over the specified time period, and (ii) are currently over the specified threshold value; and
triggering a discovery process that further analyzes the candidate rogue ONU based on the classification.

13. The system of claim 12, wherein classifying the given ONU from among the ONUs as the candidate rogue ONU comprises determining that the aggregated values of the given condition are over the specified threshold value after an integration time period after the given ONU from among the ONUs is classified as the candidate rogue ONU.

14. The system of claim 12, wherein the aggregated values of the given condition comprise a periodic ranging adjustment count (PRAC) of the given ONU.

15. The system of claim 12, wherein:
the candidate rogue ONU is one of a plurality of candidate rogue ONUs that are qualified for further analysis; and
triggering the discovery process comprises further analyzing the plurality of candidate rogue ONUs.

16. The system of claim 15, wherein classifying the given ONU from among the ONUs as the candidate rogue ONU comprises:
determining that a bit-interleaved parity (BIP) error count of the PON is currently over a PON BIP error threshold value;
aggregating BIP error counts and loss of frame (LOF) counts for each ONU among the ONUs based on the determination that the BIP error count of the PON is currently over the PON BIP threshold value;
determining that at least one of (i) the BIP count of at least one ONU among ONUs is currently over an ONU BIP error threshold value, or (ii) the LOF count of the at least one ONU among ONUs is currently over a ONU LOF threshold value; and
classifying the at least one ONU from among the ONUs as a second of the plurality of candidate rogue ONU that are qualified for further analysis based on the determination that the at least one of (i) the BIP error count of the at least one ONU among ONUs is currently over the ONU BIP error threshold value, or (ii) the LOF count of the at least one ONU among ONUs is currently over the ONU LOF threshold value.

17. The system of claim 15, wherein classifying the given ONU from among the ONUs as the candidate rogue ONU comprises:
aggregating, over a second time period, optical signal strengths values for each ONU among the ONUs;
determining that at least one of the optical signal strengths values of at least one ONU among the ONUs has increased over a optical signal strength threshold value; and
classifying the at least one ONU from among the ONUs as a second of the plurality of candidate rogue ONU that are qualified for further analysis based on the determination that the optical signal strengths values of the at least one ONU among the ONUs has increased over the optical signal strength threshold value.

18. The system of claim 17, wherein the signal strengths values for each ONU among the ONUs comprise at least one of a maximum received signal strength indicator (RSSI), a minimum RSSI, and an average RSSI.

19. The system of claim 15, wherein classifying the given ONU from among the ONUs as the candidate rogue ONU comprises:
determining that an operating state value of at least one ONU among the ONUs is over an operating threshold value; and
classifying the at least one ONU from among the ONUs as a second of the plurality of candidate rogue ONUs that are qualified for further analysis based on the determination that the operating state value of the at least one ONU among the ONUs is over the operating threshold value.

20. The system of claim 19, wherein the operating state value comprises at least one of temperature, voltage, or bias current.

21. The system of claim 15, wherein classifying the given ONU from among the ONUs as the candidate rogue ONU comprises:
determining that each ONUs among the ONUs is down;
disabling ONU discovery based on determining that each ONUs among the ONUs is down;
detecting an optical signal from at least one ONU among the ONUs; and
classifying that at least one ONU from among the ONUs as a second of the plurality of candidate rogue ONU that are qualified for further analysis based on detecting the optical signal from the at least one ONU among the ONU.

22. The system of claim 12, wherein the ONU discovery process comprises searching the PON for the at least one candidate rogue ONU.

23. A non-transitory computer storage medium encoded with instructions that, when executed by one or more processors, cause the one or more processors to perform operations comprising:
aggregating, over a specified time period, values of multiple network conditions of a passive optical network (PON) that includes optical networking units (ONUs) actively transmitting over the PON;
determining that aggregated values of a given condition (i) have statistically trended in only one direction over the specified time period, and (ii) are currently over a specified threshold value;
classifying a given ONU from among the ONUs as a candidate rogue ONU that is qualified for further analysis based on the determination that the aggregated values of the given ONU (i) have statistically trended in only one direction over the specified time period, and (ii) are currently over the specified threshold value; and
triggering a discovery process that further analyzes the candidate rogue ONU based on the classification.
